(19) United States
(12) Patent Application Publication
(10) Pub. No.: US 2026/0267208 A1
(43) Pub. Date: Sep. 10, 2026

(54) MOBILE PHONE FILTER HOLDER AND FILTER ASSEMBLY

(71) Applicant: Shenzhen Anymore Technology Limited., Shenzhen (CN)

(72) Inventors: Taorong Liu, Shenzhen (CN); Zhidong Xie, Shenzhen (CN)

(21) Appl. No.: 19/662,599

(22) Filed: Apr. 29, 2026

(30) Foreign Application Priority Data
Jan. 22, 2026 (CN) 202620087932.2

(51) Int. Cl. G03B 17/14; G02B 7/00; G03B 11/04; G03B 30/00

(52) U.S. Cl. CPC G03B 17/14; G02B 7/006; G03B 11/041; G03B 30/00; G03B 2217/002

(57) ABSTRACT

Provided are a mobile phone filter holder and filter component. The filter holder is connected to a mobile phone camera module, one side of the filter holder facing away from the mobile phone is provided with an embedded slot for detachable connection of a filter; when the filter is connected to the filter holder, a filter portion is inserted into the embedded slot, and the filter is configured to be adjusted by moving along an extension direction of the embedded slot. In summary, a magnetic connection method enhances a stability between the filter and the phone, avoiding accidental detachment of the filter during a shooting process. This design makes the filter application more flexible, and users can adjust the filter type and intensity according to their shooting environment and personal preferences, meeting their needs for improving mobile photography effects.

### CROSS-REFERENCE TO RELATED APPLICATIONS

This application claims priority to Chinese Patent Application No. 2026200879322, filed on Jan. 22, 2026, which is hereby incorporated by reference in its entirety.

### TECHNICAL FIELD

The present disclosure relates to the field of photography tools technologies, and in particular, to mobile phone filter holder and filter component.

### BACKGROUND

In modern society, smartphones have gradually become an indispensable communication and entertainment tool for people. To meet diverse photography needs, mobile phone users often install various filters on their phone lenses to beautify photos or give them special effects. Traditional filters are installed on mobile phones through specialized filter holders, such as metal clip holders. But this type of holders has a larger and heavier overall structure, rendering it inconvenient to carry; and during a clamping process, it is easy to cause problems such as phone wear and tear. Besides that, the process of installing filters is cumbersome and the efficiency of filter switching is low, resulting in many limitations in the use of mobile filters.

### SUMMARY

In view of this, to solve the problems raised in the background technology mentioned above, the purpose of the present disclosure is to provide a mobile phone filter holder and filter component.

The main objective of the present disclosure is to provide a mobile phone filter component with a simpler structure and more convenient use. Specifically, by using magnetic connection, the stability between the filter and the phone is enhanced, avoiding accidental detachment of the filter during a shooting process. The filter holder is provided with an embedded slot that matches the filter, which on the one hand renders a connection between the filter and the filter holder tighter and improves the overall stability of the filter. On the other hand, a use angle of the filter can be adjusted by moving it along an extension direction of the embedded groove. This design makes the application of the filter more flexible, and users can adjust the filter type and intensity according to their shooting environment and personal preferences, meeting their needs for improving mobile photography effects.

To achieve the above objectives, the present disclosure provides the following technical solutions.

A mobile phone filter holder, where the filter holder is connected to a mobile phone camera module, and one side of the filter holder facing away from the mobile phone is provided with an embedded slot for detachable connection of a filter;
when the filter is connected to the filter holder, a filter portion is inserted into the embedded slot, and the filter is configured to be adjusted by moving along an extension direction of the embedded slot.

In some embodiments of the present disclosure, a magnetic component is provided on the filter holder configured to limit the filter holder from detaching from the mobile phone camera module and limit the filter from detaching from the embedded slot;
the filter is a magnetic filter with a magnetic attraction structure that cooperates with the magnetic component; when the filter is partially inserted into the embedded slot, the magnetic component magnetically connects at least a part of the magnetic attraction structure.

In some embodiments of the present disclosure, the magnetic component includes at least one magnetic attraction part;
on a front projection surface of the filter holder, a projection trajectory of the embedded slot completely covers an arrangement trajectory of at least one magnetic attraction part.

In some embodiments of the present disclosure, the filter holder has a camera area adapted to the camera module lens, and the embedded slot is fitted on an outside of the camera area; when the filter is connected to the filter holder through the embedded slot, the filter completely covers an imaging area of the filter holder.

In some embodiments of the present disclosure, the camera area of the filter holder is provided with a plurality of through holes adapted to the camera module lens; when the filter holder is connected to the mobile phone camera module, the through hole is interlocked with a lens protrusion of the camera module.

In some embodiments of the present disclosure, the magnetic component and the embedded slot are respectively provided on two sides of the filter holder.

In some embodiments of the present disclosure, the filter is a circular filter, and the embedded slot is an arc groove adapted to the circular filter; when the filter is adjusted by moving along the extension direction of the embedded slot, the filter performs a rotational motion relative to the filter holder.

In some embodiments of the present disclosure, the filter holder is provided with a flashlight hole.

In some embodiments of the present disclosure, a radar hole is provided on the filter holder.

A mobile phone filter component, including the filter holder and a filter detachably connected to the filter holder; the filter includes an adjustable mirror ring and a lens provided inside the adjustable mirror ring, where a thickness of the adjustable mirror ring is greater than that of the lens;
when the filter is partially inserted into the embedded slot, the adjustable mirror ring is partially inserted into the embedded slot, and the lens covers a surface of the filter holder.

Compared with the existing technology, the present disclosure has the following beneficial effects.
(1) The present disclosure provides the mobile phone filter holder and filter component, which uses the filter holder directly attached to the mobile phone camera module instead of a traditional installation bracket. The structure is more compact and simpler, greatly improving the portability of the overall mobile phone filter component. The filter holder uses the embedded slot to install the filter, which is easy to install and allows the filter to be moved and adjusted along the extension direction of the embedded slot, rendering the application of the filter more flexible.
(2) In the present disclosure, the through hole is provided on the filter holder to match the camera module lens, and a magnetic ring is provided inside the through hole, so that the filter holder can be easily installed on the mobile phone by magnetic attraction. Compared with traditional installation brackets, it has a wider adaptability and avoids the problem of mobile phone wear and tear.
(3) In the present disclosure, a limit element is provided on the filter holder that matches the embedded slot, and the limit element adopts a magnetic component that matches the magnetic attraction of the filter, so that the filter is magnetically engaged in the embedded slot. Compared with traditional installation brackets, the disassembly and assembly of the filter is more convenient.

### BRIEF DESCRIPTION OF DRAWINGS

In order to provide a clearer explanation of the technical solution in the embodiments of the present application, a brief introduction will be given to the accompanying drawings required for the description of the embodiments. It is obvious that the drawings described below are only some embodiments of the present application. For those skilled in the art, other drawings can be obtained based on these drawings without creative work.

In order to have a more complete understanding of the present application and its beneficial effects, the following description will be made in combination with the accompanying drawings, where the same reference numbers in the following description represent the same parts.

FIG. 1 is an exploded schematic diagram of a mobile phone filter component of the present disclosure.

FIG. 2 is a first structural schematic diagram of a filter holder in the present disclosure.

FIG. 3 is a second structural schematic diagram of the filter holder in the present disclosure.

FIG. 4 is a third structural schematic diagram of the filter holder in the present disclosure.

FIG. 5 is a fourth structural schematic diagram of the filter holder in the present disclosure.

Numeral reference: filter holder—1; through hole—11; flashlight hole—12; radar hole—13; filter—2; adjustable mirror ring—21; lens—22; embedded slot—3; magnetic component—4.

### DESCRIPTION OF EMBODIMENTS

To further understand the content of the present disclosure, a detailed description of the present disclosure will be provided in combination with the accompanying drawings and embodiments. The structure, proportion, size, etc. shown in the accompanying drawings of this specification are only for the purpose of cooperating with the content disclosed in the specification, for the understanding and reading of those familiar with this technology, and are not intended to limit the conditions under which the present disclosure can be implemented. Therefore, they do not have substantive technical significance. Any modification of the structure, change in the proportion relationship, or adjustment of the size should still fall within the scope of the technical content disclosed in the present disclosure without affecting the efficacy and purpose that can be achieved by the present disclosure. Meanwhile, terms used in this specification, such as “up”, “down”, “left”, “right”, “middle”, etc., are only for the sake of clarity in description and are not intended to limit the scope of implementation. Any changes or adjustments to their relative relationships, without substantial changes in technical content, shall also be considered as the scope of implementation of the present disclosure. It should be noted that terms “first”, “second”, etc. in the specification and claims of the present application, as well as in the accompanying drawings, are used to distinguish similar objects and do not necessarily need to be used to describe a specific order or sequence. It should be understood that data used in this way can be interchanged in appropriate circumstances for the embodiments described herein.

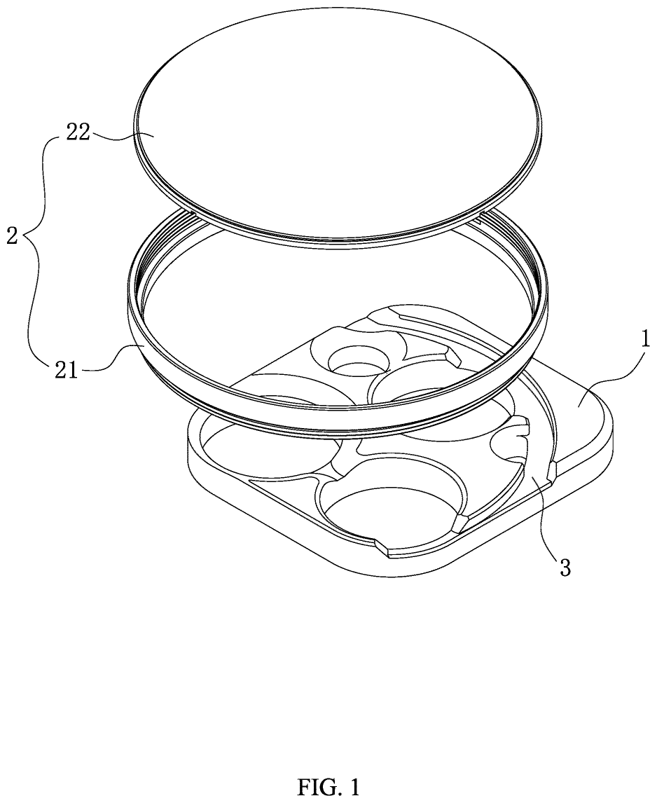

As shown in FIG. 1, the present disclosure provides a mobile phone filter component, which includes a filter holder 1 and a filter 2. The filter holder 1 is connected to a mobile phone camera module, and the filter 2 is detachably connected to the filter holder 1 through an embedded slot 3, and the embedded slot 3 is provided on a surface of the filter holder 1. Specifically, when the filter 2 is connected to the filter holder 1, a part of the filter 2 is inserted into the embedded slot 3, and the filter 2 can be adjusted by moving along an extension direction of the embedded slot 3.

According to the above structure, the present disclosure replaces the traditional installation bracket with the filter holder 1 directly attached to the mobile phone camera module, which is more compact and simple in structure, greatly improving the portability of the overall mobile phone filter component; the filter holder 1 uses the embedded slot 3 to clamp and install the filter 2, which is easy to install and allows the filter 2 to move and adjust along the extension direction of the embedded slot 3, thereby adjusting an use angle of the filter 2. This design makes the application of the filter 2 more flexible, and users can adjust the filter type and intensity according to their shooting environment and personal preferences, meeting their needs for improving mobile phone photography effects.

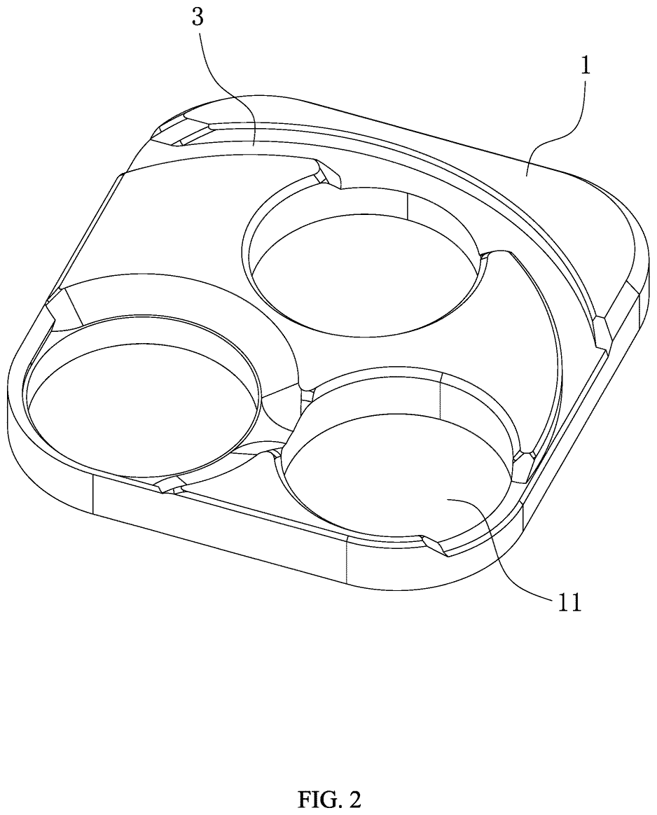

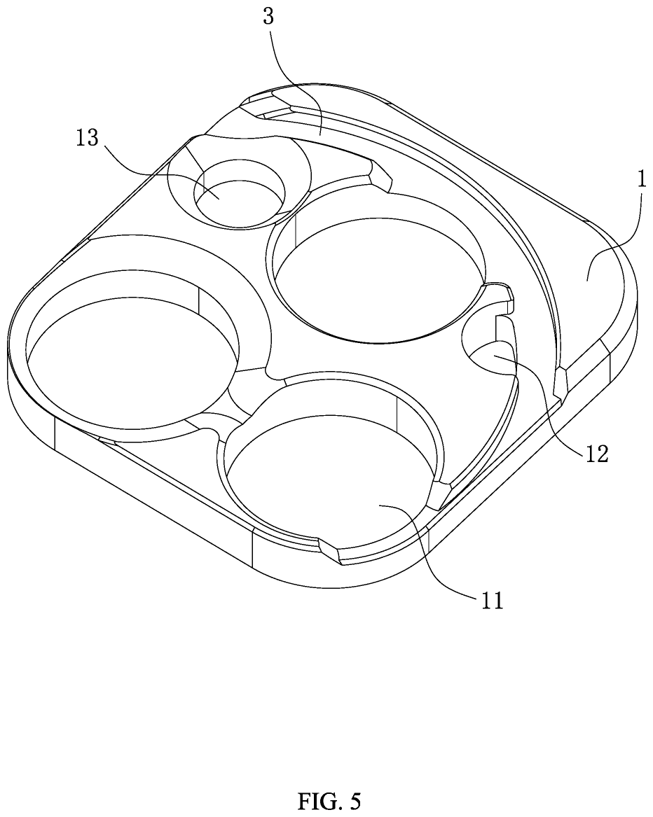

Continuing to refer to FIGS. 1-5, the filter holder 1 has a camera area that is compatible with the camera module lens, and the embedded slot 3 is fitted on an outside of the camera area. Therefore, when the filter 2 is connected to the filter holder 1 through the embedded slot 3, the filter 2 completely covers an imaging area of the filter holder 1, thereby ensuring the shooting quality of the mobile phone camera module.

In an implementation mode, there are a plurality of through holes 11 in the imaging area of the filter holder 1 that are compatible with the camera module lens. In an implementation mode, the filter holder 1 is further provided with a flashlight hole 12, a radar hole 13, etc. Specifically, according to different models of mobile phone camera modules, several different hole positions are correspondingly arranged on the filter holder 1, among which several through holes 11 that are compatible with the lens are positioned within the camera area to ensure a normal use of the mobile phone camera module.

When the filter holder 1 is installed on the mobile phone camera module, the number, position, and diameter of several through holes 11 on the filter holder 1 are consistent with a protruding part of the lens of a corresponding model of mobile phone camera module. Therefore, the filter holder 1 is installed on the corresponding model of mobile phone by interlocking with the protruding part of the mobile phone lens through the through holes 11. To enhance the an installation stability of the filter holder 1, it is preferable to install a magnetic component 4 on the filter holder 1 to magnetically limit its detachment from the mobile phone camera module.

It should be noted that the above settings are not limited, and the filter holder 1 can also be connected to the mobile phone camera module through other connection methods such as bonding or fastening.

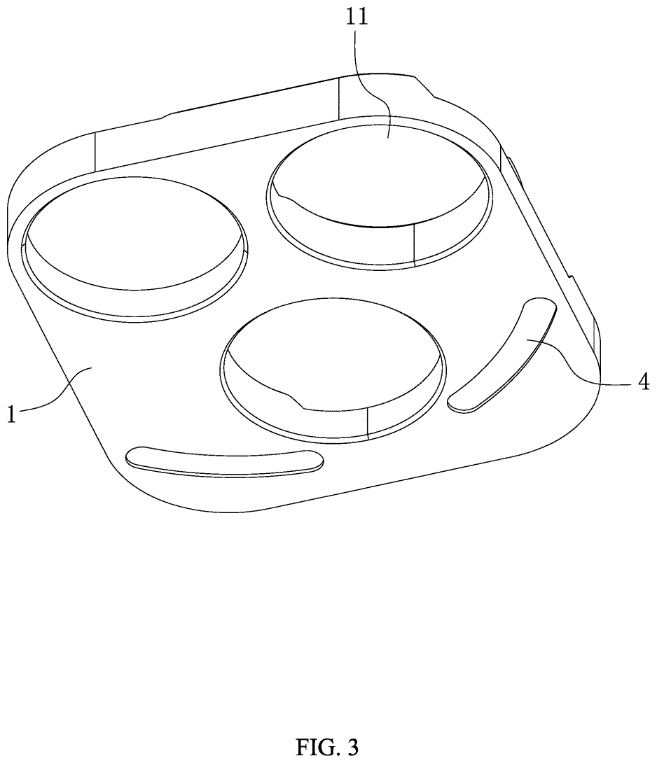

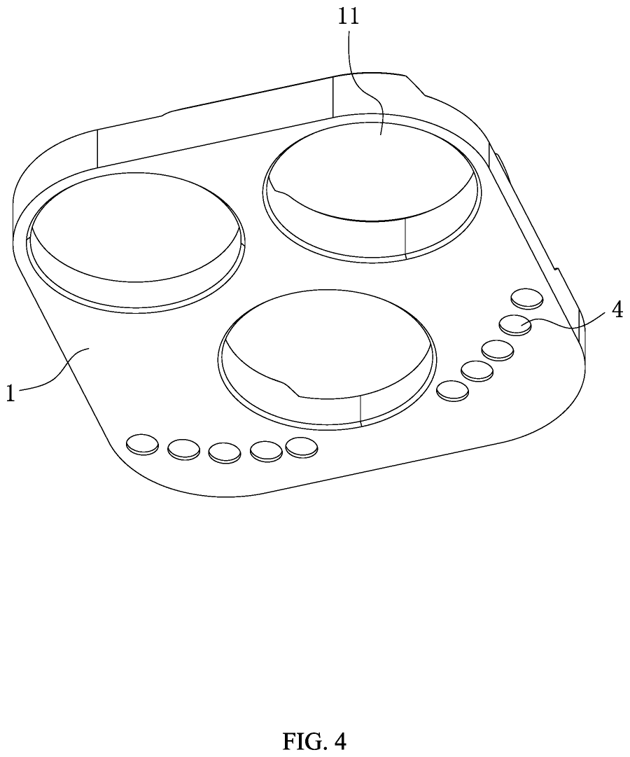

Continuing to refer to FIGS. 3 and 4, the magnetic component 4 is also used to limit the filter 2 from detaching from the embedded slot 3. The filter adopts a magnetic filter with a magnetic attraction structure that cooperates with the magnetic component 4. When the filter is partially inserted into the embedded slot 3, the magnetic component 4 is magnetically connected to at least part of the magnetic attraction structure, thereby allowing the filter 2 to be clamped in the embedded slot 3 of the filter holder 1 through magnetic connection, thereby enhancing a connection stability between the filter 2 and the mobile phone and avoiding accidental detachment of the filter 2 during shooting.

It should be noted that the magnetic attraction structure of the filter can be made of a magnetic material that can be magnetically connected to the magnetic component 4 for the adjustable mirror ring 21 (or frame) of the filter; or a magnetic ring or block that can be magnetically connected to the magnetic component 4 can be installed on the adjustable mirror ring 21 (or frame) of the filter.

In an implementation mode, the magnetic component 4 includes two magnetic suction parts arranged relatively as shown in FIG. 3, thereby achieving symmetrical fixation of the filter 2.

In an implementation mode, the magnetic component 4 includes multiple magnetic attraction parts as shown in FIG. 4, and the multiple magnetic attraction parts are arranged in two groups relative to each other, ensuring the symmetrical fixation of the filter 2.

It should be noted that whether it is two or multiple magnetic attraction parts, a projection trajectory of the embedded slot 3 on a front projection surface of the filter holder 1 can completely cover an arrangement trajectory of the two or more magnetic attraction parts of the magnetic component 4, thereby ensuring the stability of the magnetic attraction of the filter 2 limited within the embedded slot 3.

Besides that, in the illustrated structure of the present disclosure, the magnetic component 4 and the embedded slot 3 are respectively arranged on two sides of the filter holder 1, and the magnetic component 4 is embedded on the filter holder 1 to ensure a flatness of a contact surface between the filter holder 1 and the mobile phone camera module. Of course, the magnetic component 4 can also be embedded inside the embedded slot 3.

Continuing to refer to FIG. 1, the filter 2 is a circular filter, and embedded slot 3 is an arc slot that is compatible with the circular filter. Therefore, when the filter 2 is moved and adjusted along the extension direction of the embedded slot 3, the filter 2 performs a rotational motion relative to the filter holder 1. Under this structural design, users can adjust the usage angle of the filter 2 by rotating it, extending its scalability and better meeting their needs.

Continuing to refer to FIG. 1, the filter 2 includes an adjustable mirror ring 21 and a lens 22 installed inside the adjustable mirror ring 21, and a thickness of the adjustable mirror ring 21 is greater than that of the lens 22. Therefore, when the filter 2 is partially inserted into the embedded slot 3, the adjustable mirror ring 21 is partially inserted into the embedded slot 3 to ensure that the lens 22 covers the surface of the filter holder 1 so to meet the needs of filter 2 use.

In the description of the present disclosure, reference terms “one embodiment”, “some embodiments”, “illustrative embodiments”, “examples”, “specific examples”, or “some examples” refer to the specific features, structures, materials, or characteristics described in combination with the embodiments or examples included in at least one embodiment or example of the present disclosure. In this specification, the illustrative expressions of the above terms may not necessarily refer to the same embodiments or examples. Moreover, the specific features, structures, materials, or characteristics described can be combined in any one or more embodiments or examples in a suitable manner.

Note that the above are only the preferred embodiments and technical principles of the present disclosure. Those skilled in the art will understand that the present disclosure is not limited to the specific embodiments described herein, and various obvious changes, readjustments, and substitutions can be made for those skilled in the art without departing from the protection scope of the present disclosure. Therefore, although the present disclosure has been described in detail through the above embodiments, the present disclosure is not limited to the above embodiments, and may also include more equivalent embodiments without departing from the concept of the present disclosure. The scope of the present disclosure is determined by the scope of the appended claims.

What is claimed is:

1. A mobile phone filter holder, wherein the filter holder is connected to a mobile phone camera module, and one side of the filter holder facing away from the mobile phone is provided with an embedded slot for detachable connection of a filter;
when the filter is connected to the filter holder, a filter portion is inserted into the embedded slot, and the filter is configured to be adjusted by moving along an extension direction of the embedded slot.

2. The mobile phone filter holder according to claim 1, wherein a magnetic component is provided on the filter holder configured to limit the filter holder from detaching from the mobile phone camera module and limit the filter from detaching from the embedded slot;
the filter is a magnetic filter with a magnetic attraction structure that cooperates with the magnetic component; when the filter is partially inserted into the embedded slot, the magnetic component magnetically connects at least a part of the magnetic attraction structure.

3. The mobile phone filter holder according to claim 2, wherein the magnetic component comprises at least one magnetic attraction part;
on a front projection surface of the filter holder, a projection trajectory of the embedded slot completely covers an arrangement trajectory of at least one magnetic attraction part.

4. The mobile phone filter holder according to claim 1, wherein the filter holder has a camera area adapted to the camera module lens, and the embedded slot is fitted on an outside of the camera area;
when the filter is connected to the filter holder through the embedded slot, the filter completely covers an imaging area of the filter holder.

5. The mobile phone filter holder according to claim 5, wherein the camera area of the filter holder is provided with a plurality of through holes adapted to the camera module lens;
when the filter holder is connected to the mobile phone camera module, the through hole is interlocked with a lens protrusion of the camera module.

6. The mobile phone filter holder according to claim 2, wherein the magnetic component and the embedded slot are respectively provided on two sides of the filter holder.

7. The mobile phone filter holder according to claim 1, wherein the filter is a circular filter, and the embedded slot is an arc groove adapted to the circular filter;
when the filter is adjusted by moving along the extension direction of the embedded slot, the filter performs a rotational motion relative to the filter holder.

8. The mobile phone filter holder according to claim 1, wherein the filter holder is provided with a flashlight hole.

9. The mobile phone filter holder according to claim 1, wherein a radar hole is provided on the filter holder.

10. A mobile phone filter component, wherein it comprises the filter holder according to claim 1, and a filter detachably connected to the filter holder;
the filter comprises an adjustable mirror ring and a lens provided inside the adjustable mirror ring, wherein a thickness of the adjustable mirror ring is greater than that of the lens;
when the filter is partially inserted into the embedded slot, the adjustable mirror ring is partially inserted into the embedded slot, and the lens covers a surface of the filter holder.
